(19) United States
(12) Patent Application Publication
(10) Pub. No.: US 2013/0272477 A1
(43) Pub. Date: Oct. 17, 2013

(54) Pressurized Water Reactor with Skirted Lower End Fitting and Filter Plate

(71) Applicants: Julius M. Ullmann, Forest, VA (US); Lewis A. Walton, Forest, VA (US); Mary W. Johnson, Amherst, VA (US)

(72) Inventors: Julius M. Ullmann, Forest, VA (US); Lewis A. Walton, Forest, VA (US); Mary W. Johnson, Amherst, VA (US)

(21) Appl. No.: 13/537,049

(22) Filed: Jun. 29, 2012

Related U.S. Application Data
(60) Provisional application No. 61/624,325, filed on Apr. 15, 2012.

(51) Int. Cl. G21C 15/12; G21C 19/42; G21C 3/344

(52) U.S. Cl. 376/313; 376/440; 376/395

(57) ABSTRACT

In a nuclear reactor core having fuel assemblies with upper and lower end fittings, a debris filter plate is attached to a lower end fitting having a skirt. The filter prevents debris from entering the fuel assembly, while the skirt prevents the trapped debris from sliding off the lower end fitting and continuing into the core. The lower end fitting is formed from a substantially square base and has flow channels to allow coolant to flow through it to the fuel assembly. The skirt is an extension of the metal of the lower end fitting that extends around the perimeter of the lower end fitting, spanning all four corners of the lower end fitting. In addition to capturing debris, the skirt also positions the filter, which may be manufactured from the same metal as the lower end fitting.

This application claims the benefit of U.S. Provisional Application No. 61/624,325 filed Apr. 15, 2012. U.S. Provisional Application No. 61/624,325 filed Apr. 15, 2012 is incorporated herein by reference in its entirety.

### BACKGROUND

The following relates to the nuclear reactor arts, nuclear power generation arts, nuclear reactor hydrodynamic design arts, and related arts.

In nuclear reactor designs of the integral pressurized water reactor (integral PWR) type, a nuclear reactor core is immersed in primary coolant water at or near the bottom of a pressure vessel. In a typical design, the primary coolant is maintained in a subcooled liquid phase in a cylindrical pressure vessel that is mounted generally upright (that is, with its cylinder axis oriented vertically). A hollow cylindrical central riser is disposed concentrically inside the pressure vessel. Primary coolant flows upward through the reactor core where it is heated and rises through the central riser, discharges from the top of the central riser and reverses direction to flow downward back toward the reactor core through a downcomer annulus defined between the pressure vessel and the central riser. In the integral PWR design, at least one steam generator is located inside the pressure vessel, typically in the downcomer annulus. Some illustrative integral PWR designs are described in Thome et al., “Integral Helical-Coil Pressurized Water Nuclear Reactor”, U.S. Pub. No. 2010/0316181 A1 published Dec. 16, 2010, and Malloy et al., “Compact Nuclear Reactor”, U.S. Pub No. 2012/0076254 published Mar. 29, 2012, both of which are incorporated herein by reference in their entirety. Other light water nuclear reactor designs such as PWR designs with external steam generators, boiling water reactors (BWRs) or so forth, vary the arrangement of the steam generator and other components, but usually locate the radioactive core at or near the bottom of a cylindrical pressure vessel in order to reduce the likelihood of air exposure of the reactor core in a loss of coolant accident (LOCA).

The nuclear reactor core is built up from multiple fuel assemblies. Each fuel assembly includes a number of fuel rods. Spaced vertically along the length of the fuel assembly are grid assemblies which provide structural support to the fuel rods. At the top and bottom of the fuel assembly are an upper end fitting and a lower end fitting, respectively, providing structural support. The lower end fitting, sometimes called a nozzle plate, may be supported by a lower core support plate, support pedestals, or the like.

The lower end fitting is the entrance for coolant flow into its fuel assembly. The fuel assembly also includes guide tubes interspersed amongst the fuel rods. Control rods comprising neutron absorbing material are inserted into and lifted out of the guide tubes of the fuel assembly to control core reactivity. The guide tubes are welded to the grid assemblies and the upper and lower end fittings to form the structural support for the fuel assembly.

The fuel assembly is constructed so as to precisely define the spacing between adjacent fuel rods in manner that is robust against lateral forces from primary coolant flow non-uniformities, seismic vibrations, or so forth. However, debris such as metal shavings, particles, or other manufacturing byproducts or wear products can abrade or lodge in the fuel assemblies and core components, either damaging the fuel or causing local areas of reduced flow which can become thermally hot. Such damage can reduce operating efficiency and operational lifetime, and in extreme cases may cause enough damage to require a reactor shutdown to replace damaged fuel. Additionally, the debris can become activated as it flows through the core, increasing radiation levels throughout the system. Accordingly, it is desirable to filter any debris or particles out of the primary coolant before it enters the core.

One known approach to this problem is disclosed in U.S. Pat. No. 5,037,605 to Riordan, which discloses a debris filter in the form of a screen attached to the lower end fitting. U.S. Pat. Nos. 4,828,791 to DeMario, 5,009,839 to King, 5,361,287 to Williamson, 5,438,598 to Attix, and 5,490,189 to Schechter disclose other similar approaches. The use of a filtering screen at the lower end fitting has certain disadvantages. The screen can reduce primary coolant flow through the fuel assembly, or can distort the flow pattern. These effects can be enhanced if the screen becomes partially clogged with debris over time. Moreover, although the screen may prevent debris from flowing into the fuel assembly, it does not prevent debris blocked by the screen from flowing through gaps between the fuel assemblies and into the reactor core. Still further, the screen itself typically includes numerous fine features (e.g., restricted-area holes or slots forming the screen), and residue from drilling these fine features can introduce further debris into the reactor.

Disclosed herein are improvements that provide various benefits that will become apparent to the skilled artisan upon reading the following.

### BRIEF SUMMARY

In some illustrative embodiments, an apparatus comprising a fuel assembly is provided, the fuel assembly including a plurality of fuel rods arranged mutually in parallel wherein the fuel rods include a fissile material. Interspersed amongst the fuel rods are a plurality of guide tubes arranged in parallel with the fuel rods. The guide tubes are connected to an upper end fitting and a lower end fitting, wherein a lower face of the lower end fitting has a skirt defined by raised edges at the periphery of the lower face, the skirt encircling the lower face of the lower end fitting. In one embodiment, the upper and lower end fittings are square and the skirt is square. The lower end fitting may have support pads at the four corners of the lower face of the square lower end fitting with the raised edges of the skirt running between adjacent corners of the lower face. The raised edges and the support pads may be of equal height. The lower end fitting may have a debris filter plate covering the flow channels and attached to the lower face of the lower end fitting inside of and sized to fit inside the skirt. The debris filter plate may be tack welded to the lower face of the lower end fitting. To facilitate manufacture, the debris filter plate may be formed by photo-etching or laser cutting.

In some illustrative embodiments, a nuclear fuel assembly is disclosed. The nuclear fuel assembly comprises a plurality of fuel rods comprising fissile material held in place by a plurality of grid assemblies; a plurality of guide tubes extending through the grid assemblies; the guide tubes attached at their upper and lower ends to an upper end fitting and a lower end fitting, respectively, the end fittings having flow channels to allow coolant to pass; a debris filter attached to the lower end fitting to cover the flow channels and having a plurality of openings to pass coolant; and a skirt protruding from the bottom of the lower end fitting that surrounds the debris filter, the skirt having a height greater than the thickness of the debris filter. The lower end fitting may have at least one support pad, and possibly four located at four corners of the lower end fitting. The skirt may be formed either as an integral part of the lower end fitting or attached to the lower end fitting. The skirt may form a weir surrounding the debris filter. The fuel assembly may be included in a pressurized water reactor (PWR) which includes a nuclear core comprising the fuel assembly, a cylindrical pressure vessel having a vertically oriented cylinder axis and containing the nuclear core immersed in primary coolant water, and a hollow cylindrical central riser disposed concentrically with and inside the cylindrical pressure vessel, a downcomer annulus being defined between the hollow cylindrical central riser and the cylindrical pressure vessel. The fuel assembly may be included in a pressurized water reactor (PWR) which includes a cylindrical pressure vessel having a vertically oriented cylinder axis, a lower core support plate, and a nuclear core comprising fuel assemblies which are disposed on the lower core support plate with the skirt contacting the lower core support plate to define a closed perimeter surrounding the debris filter.

An illustrative method is also disclosed, comprising the steps of providing a metal plate, forming a pre-defined arrangement of openings in the metal plate to generate a debris filter plate by one of photo-etching and laser cutting, and mounting the metal plate against a lower end fitting of a fuel assembly comprising a fissile material. The method may further include the step of fitting the debris filter plate inside a peripheral skirt of the lower end fitting.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a side view of a fuel assembly with a lower end fitting.

FIG. 2 shows a perspective view of the lower end fitting of the fuel assembly of FIG. 1 without the debris filter.

FIG. 3 shows a perspective view of the debris filter that is mounted on the lower end fitting of the fuel assembly of FIG. 1.

FIG. 4 shows a perspective view of the lower end fitting of the fuel assembly of FIG. 1 with the debris filter in place.

FIG. 5 is a diagrammatic cutaway view of the lower end of the fuel assembly of FIG. 1 including the lower end fitting with debris filter mounted, and with the lower end fitting supported by a lower core support plate.

### DETAILED DESCRIPTION OF THE PREFERRED EMBODIMENTS

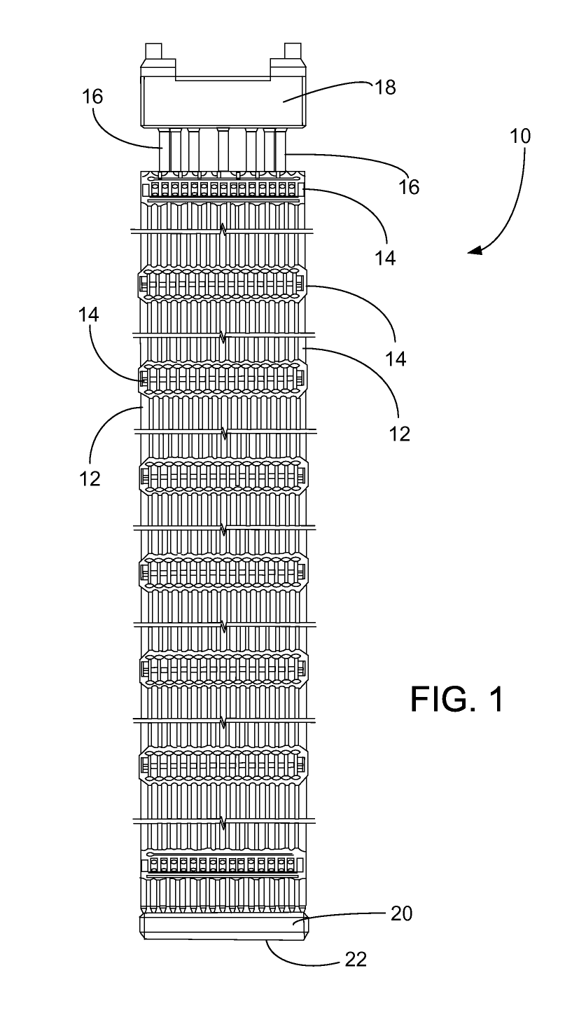

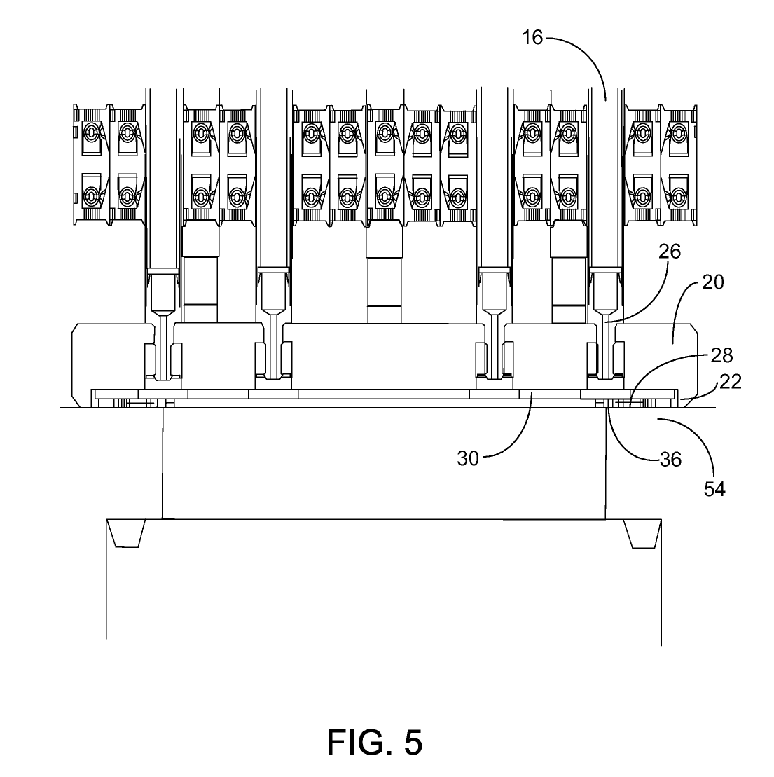

FIG. 1 illustrates a typical nuclear fuel assembly generally designated by the numeral 10. Fuel assembly 10 is typical of that used in a pressurized water reactor (PWR), and includes a plurality of fuel rods 12, grid assemblies 14, guide tubes 16, an upper end fitting 18, and a lower end fitting 20. In the installed configuration the fuel rods 12 are generally vertically oriented, although some deviation from exact gravitational vertical is contemplated, for example in maritime nuclear reactors that may tilt with ocean currents or vessel maneuvers. Fuel rods 12 are maintained in an array spaced apart by grid assemblies 14. Guide tubes 16 extend through grid assemblies 14 and connect at their ends with the upper and lower end fittings 18, 20. The assembly of the grid assemblies 14, guide tubes 16, and end fittings 18, 20 are welded together to form the structural skeleton of the fuel assembly 10. The guide tubes 16 are hollow tubes that serve as guides for control rods and as conduits for instrumentation or sensors (elements not shown). Upper and lower end fittings 18, 20 provide structural and load bearing support to fuel assembly 10 and have openings to allow coolant to flow vertically through the fuel assembly 10. Lower end fitting 20 rests on a lower core support plate 54 (see FIG. 5) of the reactor and directly above coolant inlet openings in the lower core support plate that direct coolant upward to the fuel assembly. Alternatively, in some embodiments upward primary coolant flow is sufficient to lift the fuel assembly during reactor operation, in which case the upper end fitting 18 (or springs built into the fitting, not shown) presses against an upper plate or other “stop”. The illustrative fuel assembly 10 is merely an example, and the fuel assembly may have different numbers of fuel rods, non-square cross-sections (e.g., a hexagonal cross-section in some embodiments), different numbers and arrangements of guide tubes, and so forth.

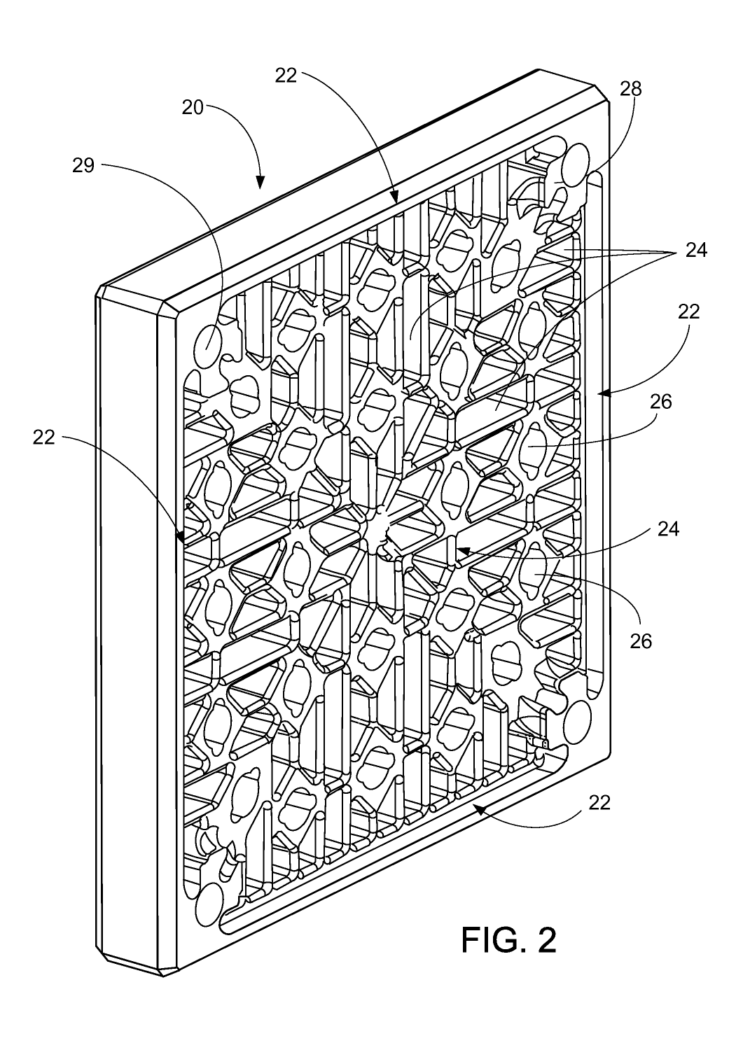

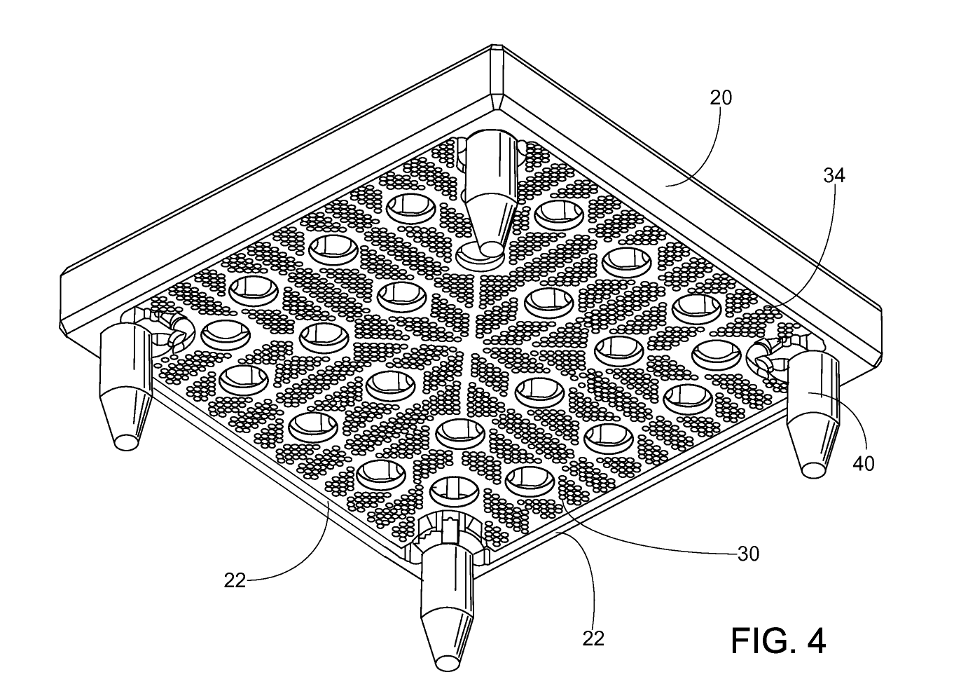

With reference to FIG. 2, lower end fitting 20 is a substantially planar square element with a plurality of flow channels 24 and guide tube bosses 26. While the illustrative lower end fitting 20 is square, more generally the lower end fitting is sized and shaped to match the cross-section of the fuel assembly 10. A lower face of the lower end fitting 20 (that is, the face that faces away from the fuel rods 12) includes a skirt 22 that is formed by raised edges running between adjacent corners along the perimeter of the square. The raised edges defining the skirt 22 at the periphery of the lower face encircle the lower face of the lower end fitting 20. Inside the square, the flow channels 24 are defined as openings or through-holes passing through the planar square element. The flow channels can have a variety of shapes, with the illustrative flow channels 24 having generally trapezoidal, rhomboidal, or rectangular shapes. Some of the illustrative flow channels 24 have clipped trapezoid, clipped rhombus, or clipped rectangle shapes where the channels are clipped by the edge of the square base. The detailed layout of the flow channels is chosen to provide a desired flow through the fuel assembly 10, and the layout is suitably designed using fluid flow modeling software. The lower end fitting also has guide tube bosses 26 that are circular, optionally with opposing protrusions, to accept guide tubes. Alternatively, guide tube bosses 26 may be substantially diamond shaped. Support pads 28 at the four corners of the lower end fitting 20 provide contact points between the lower end fitting and the core support plate 54 (see FIG. 5). Locating pins (40, shown in FIG. 4) may be attached by welding, threaded couplings, or so forth, or are integrally formed as part of the lower end fitting 20. In the embodiment shown, the locating pins attach at holes 29. The locating pins 40 mate with receiving holes in the lower core plate 54. In one embodiment, the raised edges forming the skirt 22 have the same height as the support pads 28 and join with the support pads. This forms a closed perimeter encircling the array of flow channels 24, within which debris can be trapped, preventing the debris from circulating into the core. Alternatively, the support pads can be higher than the skirt, so as to form an encircling perimeter but with a gap between the edge of the skirt and the lower core plate 54.

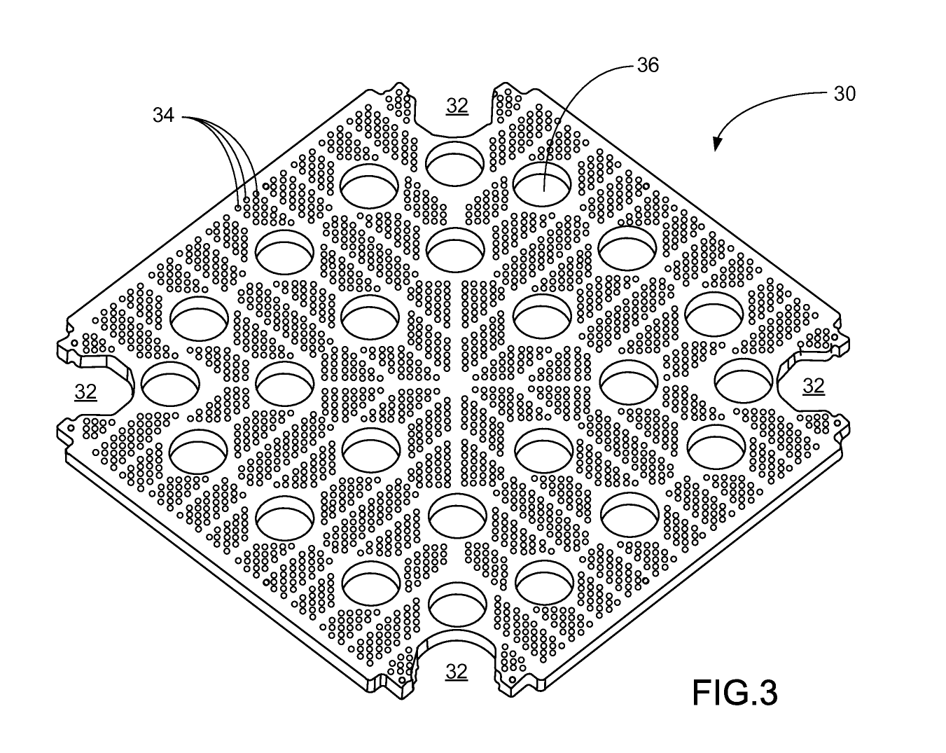

Continuing to FIG. 3, a debris filter plate 30 is attached to the lower end fitting 20. The debris filter is tack-welded or otherwise attached to the lower planar surface of the lower end fitting 20, and is sized and shaped to fit inside the edges of the perimeter skirt 22 while being large enough to cover (and hence “screen”) the flow channels 24. In one embodiment, the raised edges forming the skirt have the same height as the support pads 28 and join with the support pads. This forms a closed perimeter barrier surrounding the debris filter 30. Debris blocked by the filter 30 is prevented by the closed encircling perimeter skirt 22 from flowing laterally and into gaps between the fuel assemblies. The debris is trapped by the filter 30 and the skirt 22, preventing the debris from circulating into the core. In some embodiments, the debris filter plate is advantageously made of the same material as the lower end fitting, providing the filter plate with similar thermal expansion properties, anti-corrosion properties, strength, and neutron reflection properties as the lower end fitting. However, it is also contemplated to make the debris filter plate and the lower end fitting of different materials having similar thermal expansion properties. In some embodiments it is contemplated to size the debris filter to precisely fit inside the skirt 22 such that the debris filter plate is compressively and/or frictionally held in place by the surrounding skirt 22, such that no welding is needed. Additionally or alternatively, if the debris filter 30 has a higher rate of thermal expansion than the lower end fitting 20, then it can be configured to differentially expand relative to the skirt 22 as the reactor is brought up to operating temperature so as to compress against the skirt 22. The debris filter 30 has many small holes 34 distributed across its area which allow coolant to pass (with some flow resistance) but catch debris. The debris filter may have cutouts 32 at the corners for the locating pins and support pads of the lower end fitting. The filter also has larger holes 36 to accept the guide tubes or fasteners used to secure the guide tubes.

The debris filter plate 30 is manufactured by forming the openings 32, 34, 36 in a thin metal plate. In some embodiments, the openings 32, 34, 36 are formed by photo-etching or laser cutting. These techniques facilitate mass production and form the openings 32, 34, 36 with smooth well-defined edges, and (compared with mechanical machining approaches such as mechanical drilling) do not produce metal shavings, metal particles, rough edges, or other features that are likely to contribute to the formation of debris circulating in the reactor coolant. In one embodiment, the debris filter 30 is a plate having a thickness of 1/16^{th} inch to ⅛^{th} inch, which is thin enough to be efficiently photo etched or laser cut (and without producing a large undercut in the case of photoetching), but is thick enough to retain structural rigidity when immersed in flowing primary coolant.

FIG. 4 shows the debris filter 30 in place on the bottom of the lower end fitting 20. Coolant flows through the debris filter 30 and lower end fitting 20 in the upward direction 42 and over the fuel rods of the fuel assembly. As seen in FIG. 4, the raised edges forming the skirt 22 have a height (relative to the bottom planar surface of the lower end fitting 20) that is greater than the thickness of the filter 30 so as to allow the skirt to catch debris at the edge of the filter. This prevents the debris from flowing laterally across the debris filter and through gaps between the lower end fittings of neighboring fuel assemblies and thence into the reactor core. FIG. 4 also shows the locating pins 40 mounted in the holes 29 of the lower end fitting 20. These locating pins 40 align the lower end fitting into position respective to the lower support plate, and the support pads 28 provide a contact point with the lower support plate.

FIG. 5 shows a cutaway view of the lower portion of the fuel assembly 10 installed in the nuclear reactor. The lower end plugs of guide tubes 16 pass through the holes defined by the guide tube bosses 26, and the guide tube holes 36 in the filter plate provides access to fasteners used to secure the guide tubes 16 to the lower end fitting 20. The support pads 28 provide contact points between the lower end fitting and the lower core support plate 54. In the illustrative embodiment, the “height” of the skirt 22, that is, the extent by which the skirt protrudes away from the planar lower face of the lower end fitting 20, is equal to the “height” of the support pad 28. In this arrangement, both the skirt 22 and the support pad 28 extend to and contact with the lower core support 54 so as to form a closed perimeter seal encircling the lower face with its array of flow channels 24. This perimeter seal traps any debris that may slide off to the edge of debris filter 30. The debris filter catches debris in coolant flowing in direction 42 to the fuel assembly, but allows coolant to pass. The closed perimeter seal ensures that no debris can reach and flow through the gap between the lower end fittings of adjacent fuel assemblies.

In some embodiments, the skirt may extend to a height above the lower face of the lower end fitting that is less than the height of the support pad 28 (but the height of the skirt still should be greater than the thickness of the debris filter). In this case there is a gap between the edge of the skirt and the lower core support plate, and the skirt defines a weir over which some coolant flows. Debris that moves laterally to the edge of the debris filter is still trapped by the skirt, but if the gap between the skirt and the lower core support plate is too large then some debris may pass through this gap and then flow between adjacent fuel assemblies into the reactor core.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
a fuel assembly including:
a plurality of fuel rods arranged mutually in parallel wherein the fuel rods include a fissile material,
a plurality of guide tubes arranged in parallel with and interspersed amongst the fuel rods,
an upper end fitting connected with upper ends of guide tubes, and
a lower end fitting connected with lower ends of the guide tubes, wherein a lower face of the lower end fitting has a skirt defined by raised edges at the periphery of the lower face, the skirt encircling the lower face of the lower end fitting.

2. The apparatus of claim 1 wherein the upper and lower end fittings are square and the skirt is square.

3. The apparatus of claim 2 wherein the lower end fitting further includes support pads at the four corners of the lower face of the square lower end fitting, the raised edges running between adjacent corners of the lower face.

4. The apparatus of claim 3 wherein the raised edges and the support pads are of equal height.

5. The apparatus of claim 1 further comprising:
a debris filter plate sized to fit inside the skirt and covering flow channels passing through the lower end fitting.

6. The apparatus of claim 5 wherein the debris filter plate is disposed inside the skirt and is attached to the lower face of the lower end fitting.

7. The apparatus of claim 5 wherein the debris filter plate is tack welded to the lower face of the lower end fitting.

8. The apparatus of claim 5 wherein the debris filter plate is formed by photo-etching.

9. The apparatus of claim 5 wherein the debris filter plate is formed by laser cutting.

10. A nuclear fuel assembly comprising:
a plurality of fuel rods comprising fissile material held in place by a plurality of grid assemblies;
a plurality of guide tubes extending through the grid assemblies, the guide tubes attached at their upper and lower ends to an upper end fitting and a lower end fitting, respectively, the end fittings having flow channels to allow coolant to pass;
a debris filter attached to the lower end fitting to cover the flow channels and having a plurality of openings to pass coolant; and
a skirt protruding from the bottom of the lower end fitting that surrounds the debris filter, the skirt having a height greater than the thickness of the debris filter.

11. The fuel assembly of claim 10 wherein the lower end fitting has at least one support pad having a height, and the height of the skirt equals the height of the support pad.

12. The fuel assembly claim 11 wherein the lower end fitting has four said support pads located at four corners of the lower end fitting.

13. The fuel assembly of claim 10 wherein the skirt is formed as an integral part of the lower end fitting.

14. The fuel assembly of claim 10 wherein the skirt defines a weir surrounding the debris filter.

15. A pressurized water reactor (PWR) including:
a nuclear core comprising fuel assemblies as set forth in claim 10,
a cylindrical pressure vessel having a vertically oriented cylinder axis and containing the nuclear core immersed in primary coolant water, and
a hollow cylindrical central riser disposed concentrically with and inside the cylindrical pressure vessel, a downcomer annulus being defined between the hollow cylindrical central riser and the cylindrical pressure vessel.

16. A pressurized water reactor (PWR) including:
a cylindrical pressure vessel having a vertically oriented cylinder axis;
a lower core support plate; and
a nuclear core comprising fuel assemblies as set forth in claim 10;
wherein the fuel assemblies are disposed on the lower core support plate with the skirt contacting the lower core support plate to define a closed perimeter surrounding the debris filter.

17. A method comprising:
providing a metal plate;
forming a pre-defined arrangement of openings in the metal plate to generate a debris filter plate by one of photo-etching and laser cutting; and
mounting the debris filter on a lower face of a lower end fitting of a nuclear fuel assembly comprising a fissile material.

18. The method according to 17, wherein the mounting comprises:
fitting the debris filter plate inside a peripheral skirt of the lower end fitting.

19. The method according to 17, wherein the forming comprises:
forming the pre-defined arrangement of openings in the metal plate to generate the debris filter plate by photo-etching.

20. The method according to 17, wherein the forming comprises:
forming the pre-defined arrangement of openings in the metal plate to generate the debris filter plate by laser cutting.
